(19) United States
(12) Patent Application Publication
(10) Pub. No.: US 2013/0300365 A1
(43) Pub. Date: Nov. 14, 2013

(54) INTELLIGENT WALL-TYPE CHARGER

(71) Applicant: Zhongfang Xu, Wenling City (CN)

(72) Inventor: Zhongfang Xu, Wenling City (CN)

(21) Appl. No.: 13/883,501

(22) PCT Filed: Sep. 13, 2011
(86) PCT No.: PCT/CN11/79592

§ 371 Date: May 3, 2013

(30) Foreign Application Priority Data
Sep. 19, 2010 (CN) 201020540373.5

(51) Int. Cl. H02J 7/00

(52) U.S. Cl. CPC H02J 7/0003
USPC 320/110

(57) ABSTRACT

An intelligent wall-mounted charger comprises a housing (10) mounted on a wall. A power supplying control circuit is provided inside the housing and a display screen (80) is provided on the housing, wherein the display screen is electrically connected with the power supplying control circuit. The intelligent wall-mounted charger is mounted on the wall, and the mounting method of the intelligent wall-mounted charger is similar to that of a conventional wall-mounted switching socket. A charging interface (30) used for a notebook computer and a USB charging interface (50) applied for digital products charged through USB ports are provided on the housing of the charger. The power supplying control circuit is electrically connected with the charging interface for the notebook computer and the USB charging interfaces, and it can automatically and discriminatingly output a charging voltage for the notebook computer. The intelligent wall-mounted charger can conveniently charge a notebook computer or digital products which may be charged through USB ports.

### TECHNICAL FIELD

The invention relates to a charger for a notebook computer or other digital products and, in particular, to an intelligent wall-mounted charger.

### BACKGROUND

Various digital products, such as MP3, MP4, digital cameras, cell phones, PSPs, toys, notebook computers, etc., become essential elements in people's daily life. Each of these digital products may be provided with a charger, a data transmission cable and the like. However, it may be inconvenient if separate chargers for a variety of digital products need to be used, especially while traveling.

An object of the invention is to provide an intelligent wall-mounted charger, which can automatically charge a notebook computer or digital products with USB ports, such as cell phones, digital cameras and the like, that are connected to the charger.

### SUMMARY OF THE INVENTION

In order to remedy defects of the existing chargers discussed above, the invention provides an intelligent wall-mounted charger. The intelligent wall-mounted charger comprises a housing mountable on a wall, power supply control circuit inside the housing, and a display provided on the housing and electrically connected with the power supply control circuit. A charging port for a notebook computer and USB charging ports for digital products with USB ports may be provided on the housing; the power supply control circuit may be electrically connected with the charging port for the notebook computer and the USB charging ports, and can automatically and output selected charging voltages for notebook computers or other digital products charged through USB ports.

A charging indicator may be provided on the housing, which may be electrically connected with the power supply control circuit.

A switch for turning on/off the charger may additionally be provided on the housing, preferably on the right hand side of the charging port for notebook computers.

The charger may be provided with two USB charging ports and one charging port for notebook computers.

### DRAWINGS

FIG. 1 is a schematic diagram illustrating external structure of a charger according to a preferred embodiment of the invention.

FIG. 2 is a flow chart illustrating operation of the power supply control circuit of a charger according to a preferred embodiment of the invention.

### PREFERRED EMBODIMENTS

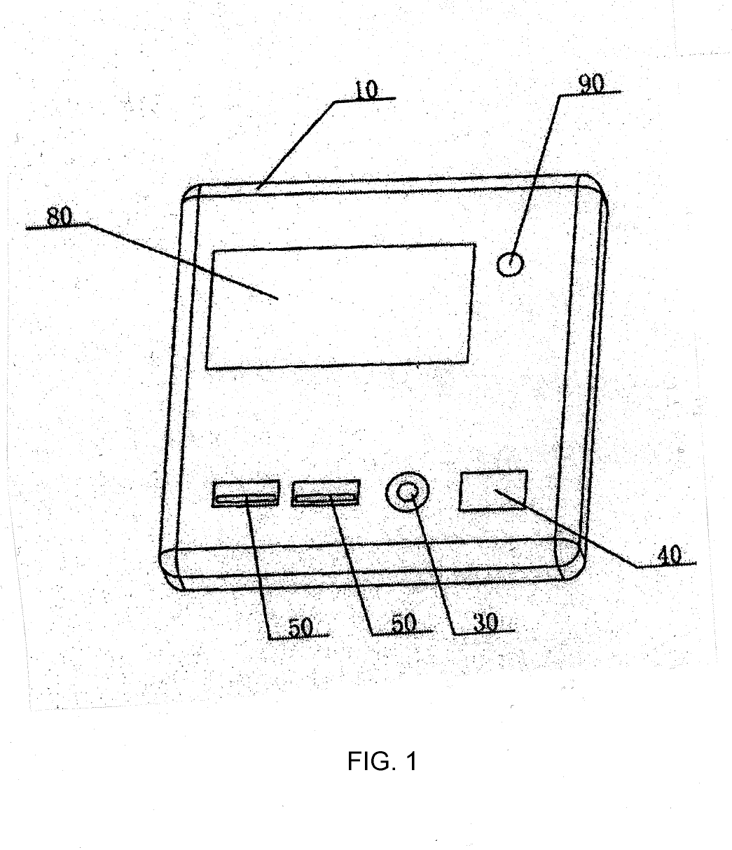

FIG. 1 shows a preferred embodiment according to the invention. An intelligent wall-mounted charger comprises a housing 10 mountable on a wall, a power supply control circuit provided within the housing 10, and a display 80 provided on the housing 10 and electrically connected with the power supply control circuit. The intelligent wall-mounted charger is mountable on a wall in similar manners as used for conventional wall-mounted power sockets. A charging port 30 for notebook computers and USB charging ports 50 for other digital products, such as cell phones, are provided on the housing 10. The power supply control circuit is electrically connected with the charging port 30 for notebook computers and the USB charging ports 50 and can automatically output selected charging voltages for notebook computers, cell phones, or other digital products connected to the charger. The intelligent wall-mounted charger can therefore automatically charge notebook computers, cell phones, or other digital products connected thereto.

The aforementioned digital products include any digital products other than notebook computers.

The charger may be provided with two USB charging ports 50 and one charging port for notebook computers.

A charging indicator 90 may additionally be provided on the housing 10 and electrically connected with the power supply control circuit. A switch 40 may further be provided on the housing 10 for turning on/off the charger. The switch may be provided on the right hand side of the charging port 30 for notebook computers.

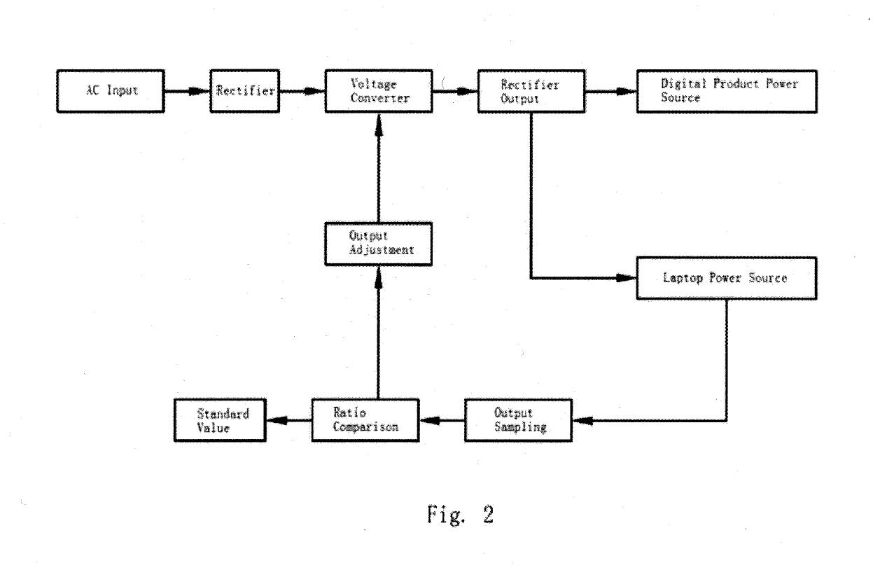

As shown in FIG. 2, the invention functions in the following manner. An AC input terminal receives alternating current input which is generally 100-240V. The input alternating current may be subject to a filtering process at the AC input terminal and then converted into high-voltage DC input through a rectifier terminal. The high-voltage DC passes through a voltage converting device and a terminal of rectified output and is converted into a low-voltage DC output. The output voltage can be directly used as a charging voltage for cell phones, digital cameras, MP3 and other 3.7-5V digital products. The voltage output from the terminal of rectified output is set as a charging voltage for cell phones, digital cameras, MP3s and other 3.7-5V low-voltage digital products by default. When a notebook computer is connected to the charger, the voltage output from the terminal of rectified output is converted to a charging voltage for the notebook computer through another DC-DC converter. A user needs to connect a charge cable of the notebook computer to the charging port 30 for notebook computers to commence charging of the notebook computer. Subsequently, power supply for the notebook computer outputs a sample voltage, which is transmitted to a comparator terminal through an output sampling terminal. At the comparator terminal, the sample voltage is compared with a standard voltage set by a standard value terminal of the system. Based on result of the comparison, an adjusting signal is output from an output adjusting terminal and transmitted to the voltage converting device. The voltage converting device then systematically adjusts the output voltage based on the result of comparison and output an adjusted voltage to the notebook computer so as to charge the notebook computer at a suitable supply voltage.

### Advantages

An intelligent wall-mounted charger according to the invention may have a wall-mounted housing, which may be provided with a charging interface for charging a notebook computer and USB charging interfaces adapted for other digital products. A supply control circuit may automatically output charging voltages for notebook computers or other digital products chargeable through USB ports and directly charging the notebook computers or the other digital products. Furthermore, said charger has stable performance and can be mounted on a wall or other objects, and is particularly convenient for travelers. The charger reliably provides optimal charging voltages for notebook computers and various digital products chargeable through USB charging interfaces. The intelligent wall-mounted charger according to the invention can be installed in guest houses, hotels and public premises such as trains, vessels, cinemas, etc. and offers travelers or users great convenience. Moreover, it will greatly reduce burden of security checks at airport, stadium, conference hall, etc. Chargers of the invention can replace existing one-for-one chargers of conventional digital appliances and plan an important role in energy saving. Additionally, application of chargers of the invention can reduce waste of resources during manufacturing of digital products, as digital product manufacturers only need to provide a USB cable for each product.

### INDUSTRIAL APPLICATIONS

The intelligent wall-mounted charger of the invention can advantageously automatically charge notebook computers or digital products, such as cell phones and digital cameras and offer convenience in direct charge of notebook computers and various digital appliances.

What is claimed is:

1. An intelligent wall-mounted charger, comprising a housing (10) mountable on a wall, a power supply control circuit provided in the housing (10), and a display (80) provided on the housing (10) and electrically connected with the power supply control circuit, wherein:
the intelligent wall-mounted charger is mountable on a wall;
a charging interface (30) for notebook computers and USB charging interfaces (50) for digital products chargeable through USB ports are provided on the housing (10); and
the power supply control circuit is electrically connected with the charging interface (30) for notebook computers and the USB charging interfaces (50) and can automatically output selected charging voltages for notebook computers or digital products chargeable through the USB ports that are connected to the charger.

2. The intelligent wall-mounted charger of claim 1, wherein the housing (10) is provided with a charging indicator (90), which is electrically connected with the power supply control circuit.

3. The intelligent wall-mounted charger of claim 2, wherein the housing (10) is provided with a switch (40) for turning on/off the charger, wherein the switch (40) is provided on the right hand side of the charging interface (30) for notebook computers.

4. The intelligent wall-mounted charger of claim 3, comprising two said USB charging interfaces (50).

5. The intelligent wall-mounted charger of claim 1, comprising one said charging interface (30) for notebook computers.
